(19) United States
(12) Patent Application Publication
(10) Pub. No.: US 2007/0122567 A1
(43) Pub. Date: May 31, 2007

(54) Method for preparing dope and method for producing cellulose triacetate film

(76) Inventors: Seiichi Ono, Minami-Ashigara-shi (JP); Tsuneo Kawase, Minami-Ashigara-shi (JP)

Correspondence Address: BIRCH STEWART KOLASCH & BIRCH, PO BOX 747, FALLS CHURCH, VA, 22040-0747, US

(21) Appl. No.: 11/699,488

(22) Filed: Jan. 30, 2007

Related U.S. Application Data
(62) Division of application No. 10/355,032, filed on Jan. 31, 2003.

(30) Foreign Application Priority Data
Feb. 1, 2002 (JP) 2002-024993
Feb. 5, 2002 (JP) 2002-027696

(51) Int. Cl. C09K 19/00; B28B 19/00

(52) U.S. Cl. 428/1.31; 264/239

(57) ABSTRACT

A dope is prepared by quickly and completely dissolving a polymer in a solvent. The solvent is supplied from a solvent tank to a solution tank. A measuring apparatus measures 15 to 20% by weight of a polymer with respect to the solvent and feeds the polymer to the solution tank. 5 to 15% by weight of a plasticizer with respect to the polymer is fed from a plasticizer tank to the solution tank. Stirring is carried out at 80 rpm for 30 minutes using a stirring blade in the solution tank so as to obtain a roughly dissolved solution. The roughly dissolved solution is heated at 85° C. for 10 minutes with a heater, so that all components necessary for a dope are dissolved, and only impurities are filtrated with a filtration filter. This filtrate is supplied to a dope tank, and it is used as a dope which is used in production of a film by solution film processing. A film produced from the dope has a retardation of 40 nm, and the film has little optical anisotropy and excellent optical performances.

This application is a Divisional of co-pending application Ser. No. 10/355,032 filed on Jan. 31, 2003, and for which priority is claimed under 35 U.S.C. § 120; and this application claims priority of Application No. 2002-024993 filed in Japan on Feb. 1, 2002 and Application No. 2002-027696 filed in Japan on Feb. 5, 2002 under 35 U.S.C. § 119; the entire contents of all are hereby incorporated by reference.

### BACKGROUND OF THE INVENTION

1. Field of the Invention

The present invention relates to a method for preparing a dope and a method for producing a cellulose triacetate film, particularly to a method for preparing a dope which is used for a polarizing plate film, an optical-purpose film, a film for liquid crystal displays (LCD), a film for organic electro luminescence (EL) devises and others, and a method for producing a cellulose triacetate film.

2. Description of the Related Art

A film produced from cellulose acylate, especially cellulose triacetate having an average acetification degree of 57.5 to 62.5% (hereinafter referred to as a TAC film), is used as a substrate for photographic-sensitized materials because of its strength and fire resistance. Moreover, since the TAC film has excellent optical isotropy, the film is suitable to be used as the protecting film or color filter of the polarizing plate of a liquid crystal display, the market of which has recently been expanded.

The TAC film is generally produced by the solution film processing method. When compared with other methods such as the melt-cast processing method, the solution film processing method enables to produce films with excellent optical characters and properties. The solution film processing method produces a film by preparing a dope by dissolving a polymer in a solvent (mainly an organic solvent), and then casting the obtained dope on a substrate such as a band or drum.

However, for some cellulose esters (TAC in particular) used in film production by the solution film processing method, natural materials are used as raw materials. Of these, some natural materials contain a small amount of ingredients which are not dissolved or are hardly dissolved in a main organic solvent. Moreover, cellulose ester and other raw materials may contain impurities, or extraneous materials may be mixed in raw materials in processes of carrying and dissolving them. These foreign materials are removed with a filter in a solution supplying process. In order that the composition of a polymer dissolved solution is held constant, it is necessary that the polymer is completely dissolved in an organic solvent upstream of this filter, which is directed towards the elimination of foreign materials. Usually, this reaction progresses in a solution tank in which raw materials are charged so as to perform dissolution and mixing. A large agitator having ultimate shearing power is required to completely dissolve the polymer in the solution tank, and further, the time required for the reaction is prolonged.

When a matting agent is used as an additive to improve the slipping or anti-adhesive property of a produced film, there is a risk that the matting agent might be trapped when the dope is filtrated and thereby the amount of the matting agent contained in the film might be reduced, or that the trapped matting agent might be flown out and foreign materials caused by the matting agent might be generated.

As measures against these problems, various methods have been proposed. For example, Japanese Patent Application Publication No. 7-11055 proposes a method which comprises mixing and dispersing both a matting agent and an ultraviolet absorber together, and mixing the thus obtained dispersion solution in a dope immediately before the use of a casting die. However, this method has a problem that since a matting agent and an ultraviolet absorber are mixed and dispersed together, the mixing ratio of the matting agent and the ultraviolet absorber cannot be easily changed, and further that the amount of the matting agent and the ultraviolet absorber in a film cannot be arbitrarily changed. Furthermore, this method has another problem that dispersion amount is increased. On the other hand, another method of mixing only the matting agent in a dope immediately before the use of a casting die has been proposed. However, this method has a risk that a matting agent could not be sufficiently dispersed in a dope, and foreign materials due to the aggregation of the matting agent might be generated.

### SUMMARY OF THE INVENTION

In view of these circumstances, the present invention has been completed, and it provides a method for preparing a dope by quickly and completely dissolving a polymer in a solvent, and a solution film processing method for producing a film by using the dope.

Moreover, it is an object of the present invention to provide a method for producing a cellulose triacetate film, which enables to suppress the generation of foreign materials caused by a matting agent and to control the amount of the matting agent and the amount of an additive separately. Furthermore, it is another object of the present invention to provide a cellulose triacetate film produced by this method and a polarizing plate produced from this film.

As a result of intensive studies directed towards the above-described objects, the present inventors have found that, when only mixing and stirring were performed to obtain a roughly dissolved solution containing a gel-state polymeric insoluble product in a solution tank in which raw materials (a polymeric solid content and an organic solvent) are charged, so as to reduce the solution time, and the dissolution is then promoted in a solution supplying process so that the roughly dissolved solution is completely dissolved before a filtration filter, the preparation of a dope can efficiently be carried out and the preparation time can be reduced. According to these findings, processes in the dope preparation can be speeded up.

In order to attain the above-described object, the present invention is directed to a method for preparing a dope by dissolving a polymer in a solvent, comprising: a first step of roughly dissolving the polymer in the solvent; and a second step of promoting the dissolution by supplying the solution roughly dissolved in the first step so as to prepare the dope. The term “roughly dissolved solution” is used to mean a solution in which a part of polymer is remained in a solvent in an insoluble state.

In the second step, it is preferable to heat the solution roughly dissolved in the first step so as to promote the dissolution. Moreover, the heating process is preferably a process of using a shell-and-tube heat exchanger. Furthermore, the heating process is preferably a process of using a spiral heat exchanger having high heat exchange efficiency. Otherwise, the heating process may be a process of using a static mixer having a heating device.

Preferably, 50 to 90% by weight of the polymer in the prepared dope is dissolved in the solvent in the first step.

Preferably, the method further comprises a step of cooling the dope after the second step. More preferably, the method further comprises a step of removing an insoluble product in the dope after the second step. Furthermore, the method preferably comprises steps of cooling the dope and removing an insoluble product in the dope after the second step.

In the first step, the dope is preferably processed using a solution comprising 0.1 to 25.0% by weight of the polymer with respect to the solvent. Moreover, in the first step, the dope is preferably processed using a solution comprising 0.1 to 20.0% by weight of a plasticizer with respect to the polymer. The solution may be a recycled solution used in washing in each step or the like. Moreover, the polymer is preferably cellulose ester. Furthermore, the cellulose ester is preferably cellulose acetate having an average acetification degree of 58.0 to 62.5%.

The solvent preferably comprises halogenated hydrocarbon as a main ingredient. More preferably, halogenated hydrocarbon in the solvent constitutes 70 to 95% by weight of the solvent.

The present invention is also directed to a solution film processing method for producing a film, comprising a step of casting the dope obtained by any one of the above-described dope preparation methods. The present invention is also directed to a solution film processing method for producing a film, comprising: a step of preparing at least two types of dope by any one of the above-described dope preparation methods; and a step of co-casting the at least two types of dope. The present invention is also directed to a solution film processing method for producing a film, comprising: a step of preparing at least two types of dope by any one of the above-described dope preparation methods; and a step of sequentially casting the at least two types of dope. In these cases, preferably, the dope is continuously cast on a non-terminal substrate in the casting step. Further, the film is preferably drawn along at least one axis when the film is produced.

It is preferable to produce a film, whose retardation in the thickness direction of the produced film is within a range of 1 to 200 nm. Retardation (hereinafter referred to as “Rth” at times) is an index showing the optical property value of the produced film, and the value is obtained by the following formula:
Rth={(nMD+nTD)/2−nTH}×d
where nMD represents the refractive index of the film in the horizontal direction, nTD represents the refractive index of the film in the vertical direction, nTH represents the refractive index of the film in the thickness direction, and d represents the thickness of the film. The smaller the value of Rth, the smaller the optical anisotropy that can be obtained, and it is therefore preferable that the value of Rth is small.

Moreover, the inventive solution film processing method for producing a film includes the production of a film used as a polarizing plate protecting film, the production of a film used as a polarizing plate, and the production of a film used as a functional optical film.

In order to attain the above-described objects, the present invention is directed to a method for producing a cellulose triacetate film comprising a matting agent and an additive, the method comprising: a step of preparing a matting agent solution and an additive solution separately; a step of mixing the matting agent solution and the additive solution into a mixed solution; a step of continuously mixing the mixed solution with a dope of cellulose acetate; and a step of casting the dope so as to produce the film.

According to the present invention, since the prepared matting agent solution is mixed with the additive solution, and then the mixture is further mixed with a dope, the matting agent is fully dispersed and cast. Accordingly, no foreign materials are generated by the aggregation of the matting agent. Moreover, since a matting agent is not mixed when a dope is processed, the matting agent is not captured when the dope is filtrated, and therefore the reduction of the matting agent and the generation of foreign materials caused by the agent can be prevented.

Furthermore, according to the present invention, since the matting agent solution and the additive solution are prepared separately and then mixed, the amount of the matting agent and the amount of the additive can independently be set easily.

Preferably, the mixing steps are carried out using an in-line mixer, so that a continuous processing becomes possible, thereby improving production efficiency.

Preferably, the matting agent comprises at least one of silicon dioxide and a derivative of silicon dioxide. The additive applied to the present invention would be an ultraviolet absorber comprising a benzotriazole compound, a phosphoric ester plasticizer, a triazine compound, a cyclohexane trans-dicarboxylic-ester compound and a mixture thereof. When the additive is a mixture of two or more types of the compounds, a mixed solution of two types of the compounds may be prepared in advance, or each type of the compounds may be added one after another, using an in-line mixer.

The cellulose triacetate film produced according to the present invention is particularly excellent in optical properties, and this film is appropriate for the production of a polarizing plate.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic diagram of a device, which is used to carry out the method for preparing a dope of the present invention;

FIG. 2 is a schematic diagram of a device, which is used to carry out the solution film processing method for producing a film of the present invention;

FIG. 3 is a schematic diagram of key parts of another device, which are used to carry out the solution film processing method for producing a film of the present invention;

FIG. 4 is a schematic diagram of key parts of another device, which are used to carry out the solution film processing method for producing a film of the present invention;

FIG. 5 is a conceptual diagram showing the general configuration of a film production system, which carries out the method for producing a cellulose triacetate film of the present invention;

FIG. 6 is a cross-sectional diagram showing the configuration of a static mixer;

FIGS. 7(A) to 7(E) are structural diagrams showing examples of the molecular structure of an ultraviolet absorber;

FIG. 8 is a structural diagram showing an example of the molecular structure of an ultraviolet absorber; and

FIGS. 9(A) and 9(B) are structural formulas of compounds used in examples.

### DETAILED DESCRIPTION OF THE PREFERRED EMBODIMENTS

The preferred embodiments of the inventive method for preparing a dope and the inventive method for producing a cellulose triacetate film will be explained in detail below, using attached drawings.

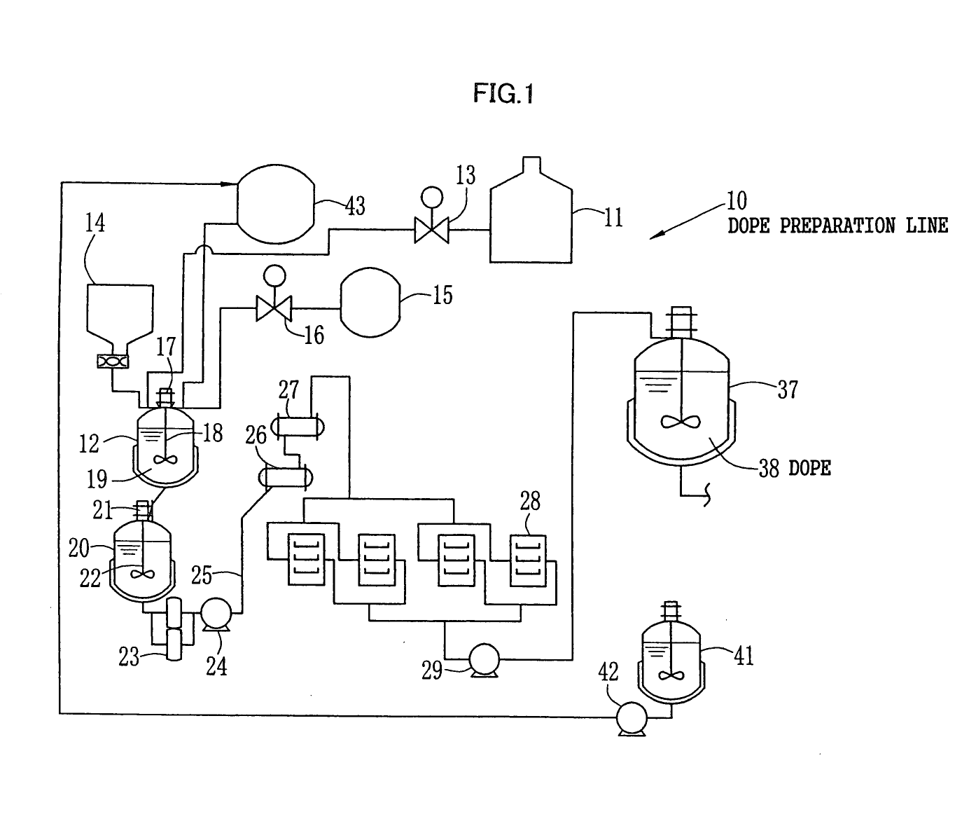

FIG. 1 is a schematic diagram showing an example of a dope preparation line 10, which is used to carry out the method for preparing a dope of the present invention.

As shown in FIG. 1, in the method for preparing a dope, first, a necessary amount of solvent is supplied from a solvent tank 11 to a solution tank 12. The solvent tank 11 is charged with the solvent (in the following explanation, referred to as simply “solvent” at times even in the case of using a mixed solvent). A solvent tank switching valve 13 installed between the solvent tank 11 and the solution tank 12 supplies this solvent, while controlling the amount of the solvent supplied.

Then, a polymer stocked in a measuring apparatus 14 is fed to the solution tank 12, while the polymer is measured. The polymer is mixed into the solvent preferably at 15.0 to 25.0% by weight with respect to the solvent, and the quality of a film which is obtained by processing a dope prepared with such a polymer, becomes good. However, the amount of the polymer mixed into the solvent is not limited to the above-described range in the present invention. TAC is preferably used as a polymer, but the polymer used is not limited thereto.

Thereafter, a plasticizer is fed from a plasticizer tank 15 to the solution tank 12. A plasticizer tank switching valve 16 is installed between the plasticizer tank 15 and the solution tank 12, and the valve feeds a necessary amount of the plasticizer to the solution tank 12. Triphenyl phosphate is preferably used as a plasticizer, but the plasticizer used is not limited thereto. Moreover, in FIG. 1, a solution obtained by dissolving a plasticizer in a solvent is supplied to the solution tank 12, but the present invention is not limited to this method. When the plasticizer has an ordinary temperature and it is a liquid, it is also possible to supply the plasticizer as a liquid state to the solution tank 12. In contrast, when the plasticizer is a solid, it is also possible to feed the plasticizer to the solution tank 12, using a measuring apparatus. In the present invention, when the amount of the plasticizer fed to the solution tank 12 is 5.0 to 15.0% by weight with respect to the polymer, the plasticity of a film produced from the thus prepared dope becomes the most preferable as a product, and the film has sufficient flexibility. However, the amount of the plasticizer fed to the solution tank is not limited to the above-described range in the present invention.

In the above explanation, materials are fed to the solution tank 12 in the order of the solvent, the polymer and the plasticizer, but the present invention is not limited to this order. For example, it is also possible that a polymer is measured and fed to the solution tank 12, and then a preferred amount of solvent is supplied thereto. Moreover, the plasticizer is not necessarily fed to the solution tank 12 in advance, but it can be mixed into a mixture of the polymer and the solvent in a latter process (hereinafter, a mixture of these materials is also referred to as a dope at times). Furthermore, it is also possible to feed the above-described additives other than the plasticizer to the solution tank 12.

The solution tank 12 is equipped with a stirring blade 18 rotated by a motor 17. The solvent and the polymer fed to the solution tank 12, and the plasticizer and other additives fed thereto as necessary, are stirred by rotation of the stirring blade 18, so that a solute such as the polymer is roughly dissolved in the solvent. Rough dissolution means a state in which a solute is not completely dissolved in a solvent. In the following explanation, the solution which is roughly dissolved is referred to as a roughly dissolved solution 19. To prepare the roughly dissolved solution 19 in the present invention, a time of stirring by the stirring blade 18 in the solution tank 12 is preferably 30 to 90 minutes, but the time is not limited to this range. If the stirring time is shorter than 20 minutes, the amount of a dissolved solute such as a polymer is too small and so the solute cannot completely be dissolved even by dissolution by heating described later, and therefore there is a risk that a dope could not be prepared. On the other hand, if a dope is prepared by stirring over 120 minutes in the solution tank 12, the purpose of the present invention that a dope with a good quality is obtained in a shorter time cannot be achieved.

A continuous batch system is preferable in terms of cost, wherein a process of supplying the roughly dissolved solution 19 to a storage tank 20 and evacuating the solution tank 12 to prepare the roughly dissolved solution 19, is carried out repeatedly. The storage tank 20 is also equipped with a stirring blade 22 which is rotated by a motor 21, and this stirring blade stirs the supplied roughly dissolved solution 19 so as to make the solution homogeneous. The roughly dissolved solution 19 in the storage tank 20 is preferably passed through a rough filtration filter 23 so as to remove impurities such as refuse which are unnecessary for the preparation of a dope. However, the rough filtration filter 23 is not necessarily installed. The roughly dissolved solution 19 in the storage tank 20 is passed though a piping 25 by a pump 24 and supplied to a heater 26. This process is not limited to that shown in the figure.

When the roughly dissolved solution 19 is supplied from the pump 24 to the heater 26, the piping 25 is preferably kept warm or heated. This is because a solute such as a polymer which is not dissolved in a solvent in the roughly dissolved solution 19, can be dissolved by being heated when the roughly dissolved solution 19 is passed through the piping 25, so that a dope can be prepared in a short time.

Thereafter, a solute such as a polymer which is necessary for the production of a film, is dissolved by heating the roughly dissolved solution 19 with the heater 26, so that a dope can be prepared. A heating time is preferably 5 to 30 minutes and a heating temperature is preferably 60° C. to 120° C., but these conditions are not limited to these ranges. If the heating time is shorter than 5 minutes, there is a risk that the preparation of a dope might not completely be carried out. On the other hand, if the heating time is over 30 minutes, it is waste of time because a necessary solute component might have already been completely dissolved in a solvent, and also there is a risk that the prepared dope might deteriorate. Further, if the heating temperature is lower than 50° C., there is a risk that the preparation of a dope might not completely be carried out, and if the heating temperature is over 120° C., a necessary solute component might be denatured.

In order to prepare a dope efficiently, a shell-and-tube heat exchanger or an in-line mixer such as a static stirring mixer (referred to also as a static mixer) which is equipped with a double- or more pipe and has a heating device, is preferably used as the heater 26, so that a time of preparing a dope can be reduced. Especially from the viewpoint of heat exchange efficiency, it is more preferable to use a spiral heat exchanger. The spiral heat exchanger is configured with two fluid-flow channels obtained by winding two plates from the center in a spiral state. This structure enables a large heating area with respect to the cross section of the fluid-flow channel for a processed solution, and therefore this heat exchanger is extremely excellent in heat exchange efficiency. Materials with high corrosion resistance are preferably used as the materials for the heater 26, and specifically, materials comprising stainless steel, titanium, Hastelloy (trade name) and others are more preferably used. By using these materials, the mass production of a dope can be speed up without changing the capacity of the solution tank 12.

To prepare a dope used to produce a film with a good quality, it is preferable to feed the dope prepared by the heater 26 to a cooler 27 so as to cool the dope to the boiling point or lower of the main solvent constituting the dope. Generally, dichloromethane (methylene chloride) is used as the main solvent constituting the dope, and in this case, the dope is preferably cooled to a temperature range of 30° C. to 38° C. However, the prepared dope is not necessarily cooled by the cooler 27 in the present invention.

The method for preparing a dope from the roughly dissolved solution 19 is not necessarily carried out using the heater 26 in the present invention. For example, in some cases, a dope can be prepared only by supplying the roughly dissolved solution 19 while heating the piping 25. In other cases, a dope can be prepared by quickly rotating the stirring blade 22 in the storage tank 20. These methods for preparing a dope from the roughly dissolved solution 19 are not necessarily limited to the heating method of using the heater 26.

In the above explained dope preparation method, in order to obtain a dope with a good quality in a short time, provided that a polymer contained in the prepared dope is defined as 100% by weight, it is preferable that 50 to 90% by weight of the polymer is dissolved in advance in the roughly dissolved solution 19. However, the present invention is not limited to this range of figures.

The dope prepared by the above-described method is passed through a filtration filter 28 to remove impurities unnecessary for film production. That is to say, it is essential that components necessary for film production are completely dissolved in the dope immediately before being passed through the filtration filter 28 for filtrating these impurities. At this time, if insoluble solute components are remained in the dope, the components are removed by the filtration filter 28, and thereby the mixing ratio of the solvent and the solute such as a polymer which are fed to the solution tank 12 is changed, so that a dope having a mixing ratio of interest cannot be obtained. In FIG. 1, four filtration filters 28 which are installed in parallel are shown as an example, but the present invention is not limited to this embodiment. The dope passing through the filtration filter 28 to remove impurities is supplied to a dope tank 37 by a pump 29, and the dope becomes a homogeneous dope 38.

On the other hand, a waste liquid obtained after washing the filtration filter 28 is supplied to a post-filter washing solvent tank 41 by a non-shown piping. This waste liquid is processed by a non-shown solution processing device and then supplied to a recycled solution tank 43 by a pump 42. This recycled solvent is fed to the solution tank 12 and used as a solvent for dope preparation. This recycled solution preferably comprises 0.1 to 25.0% by weight of a polymer with respect to the solvent to prepare a homogeneous dope. Moreover, this recycled solution preferably comprises 0.1 to 20.0% by weight of a plasticizer with respect to the polymer in the solution.

Although schematic representation is omitted in the figure, a more preferred operation for continuously operating the dope preparation line 10 includes passing the previously prepared dope through a filter which is newly used, before switching the filtration filter 28.

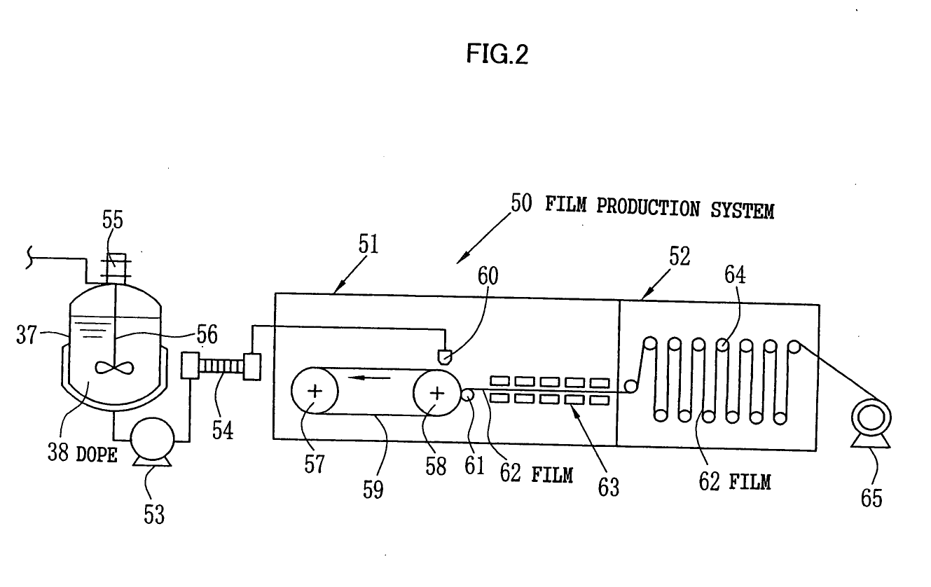

FIG. 2 is a schematic diagram showing an example of a film production system for carrying out the solution film processing method of the present invention, which produces a film by casting the dope prepared by the method for preparing a dope of the present invention.

As shown in FIG. 2, a film production system 50 is divided into a band zone 51 and a dry zone 52. The dope tank 37 containing the dope 38 is connected to the film production system 50 by means of a pump 53 and a filter 54. Moreover, a stirring blade 56 which is rotated by a motor 55 is installed to the dope tank 37, so that the stirring blade constantly makes the dope 38 homogeneous. As a solvent used to prepare the dope 38, a commercially available solvent can be used, but solvents recovered from the film production system 50 can be mixed and used.

The band zone 51 is equipped with a cast band 59 running around supporting drums 57 and 58. This cast band 59 is rotated by a non-shown drive. A casting die 60 is provided above the cast band 59. The dope 38 is supplied from the dope tank 37 by the pump 53, and after impurities are removed by the filter 54, the dope is supplied to the casting die 60. The casting die 60 casts the dope 38 on the cast band 59. While the dope 38 is carried by the cast band 59, it is gradually dried so as to have a self-supporting capacity. Then, the dope is stripped off from the cast band 59 by a stripping roller 61, and thus, a film 62 is formed.

The film 62 is dried while being carried by a tenter 63. At this time, it is preferable that at least one axis is drawn to a certain width. In FIG. 2, the dope 38 is cast on the cast band 59 that is a non-terminal substrate. However, the present invention is not limited to the embodiment shown in the figure but it is also applicable to a solution film processing method for producing a film in which a dope is cast on a rotating drum.

The film 62 which is fed to the dry zone 52 by the tenter 63 is dried therein by being carried by a plurality of rollers 64. After drying, the film 62 is wound up by a winding up machine 65. In order that the film 62 is dried uniformly, the temperature in the dry zone 52 is preferably controlled in a range of 50° C. to 150° C.

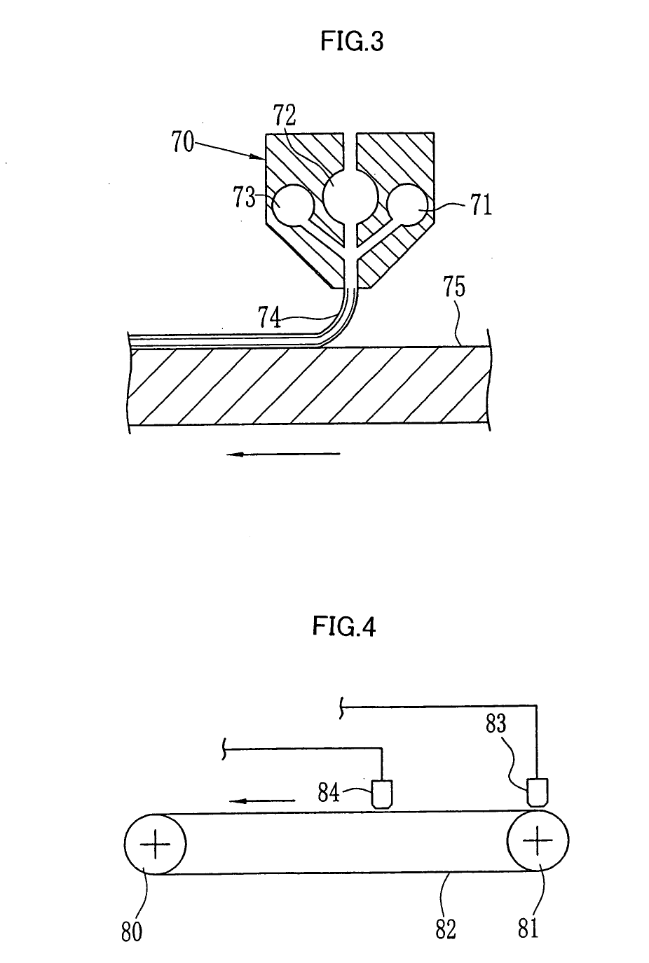

FIG. 2 shows a solution film processing method for producing a film in which the used casting die 60 is a single-layer casting die. However, the present invention is also applicable to other solution film processing methods. For example, the present invention is applicable to a solution film processing method by co-casting using a casting die 70 comprising a multi-manifold as shown in FIG. 3. This casting die 70 is a multi-manifold comprising a plurality of manifolds (3 manifolds in FIG. 3). A dope for back layer, a dope for interlayer and a dope for front layer, all of which are prepared by the above-described method for preparing a dope, are charged in manifolds 71, 72 and 73, respectively. These dopes are mixed in the casting die 70, and then a cast ribbon 74 is cast on a cast band 75 so as to form a film. In the present invention, the number of layers of dopes laminated during co-casting is not limited to the three layers shown in the figure.

FIG. 4 shows a part of a schematic diagram of an example in which the present invention is applied to a solution film processing method for producing a film by continuously casting a dope (sequential casting). In this method, a cast band 82 running around bearing drums 80 and 81 provided in a band zone is rotated by a non-shown drive. Two casting dies 83 and 84 are located above the cast band 82. From each of the casting dies 83 and 84, a dope for back layer and a dope for front layer which are prepared by the above-described method for preparing a dope are cast so that a film is formed. In the present invention, the film production by sequential casting is not limited to this embodiment of using two casting dies shown in the figure, but three or more casting dies located above the cast band 82 may also be used.

In order to use the obtained film for products described later, the film produced by any one of the above-described solution film processing methods preferably has an Rth (retardation) of a range of 1 to 200 nm.

The film produced by the above-described solution film processing methods can be used as a polarizing plate protecting film. A polarizing plate can be formed by attaching these polarizing plate protecting films to both sides of a polarizing film made of polyvinyl alcohol or the like. Moreover, the present film can be used as a functional optical film such as an optically compensated film obtained by attaching an optically compensating sheet on a film or antireflection film obtained by laminating an antiglare layer on a film. It is also possible to constitute a part of a liquid crystal display from these products.

FIG. 5 is a schematic diagram showing an example of a production system used to carry out the method for producing a cellulose triacetate film of the present invention.

As shown in FIG. 5, a mixing tank 112 is provided in a cellulose triacetate film production system 110, and this mixing tank 112 stores a dope 114. The dope 114 is stirred in the mixing tank 112, supplied to a filtration device 118 by a pump 116 and then filtrated by the filtration device 118. The filtrated dope 114 is supplied to a first in-line mixer 122 through the medium of a solution supplying line 120 and then supplied to a casting die 124.

Casting methods of using the casting die 124 include the co-casting of using a casting die comprising a multi-fold shown in FIG. 3 and the sequential casting of using multiple single-layer dies which are located in parallel as shown in FIG. 4, as well as the single-layer casting of using a single-layer die.

An addition line 126 is connected to the solution supplying line 120 which is located between the first in-line mixer 122 and the filtration device 118. The addition line 126 is also connected to a second in-line mixer 128. The second in-line mixer 128 is connected to a stock tank 132 through the medium of a matting agent solution line 130 and also connected to a stock tank 136 through the medium of an additive solution line 134. The stock tank 132 stores a matting agent solution obtained by preparing a certain amount of a matting agent by dispersion and filtrating it, whereas the stock tank 136 stores an additive solution obtained by preparing a certain amount of an ultraviolet absorber and filtrating it. These matting agent solution and additive solution are supplied to the second in-line mixer 128 and mixed therein. Thereafter, a mixed solution of the matting agent solution and the additive solution is poured into the dope 114 in the solution supplying line 120 through the medium of the addition line 126, and these materials are then mixed in the first in-line mixer 122.

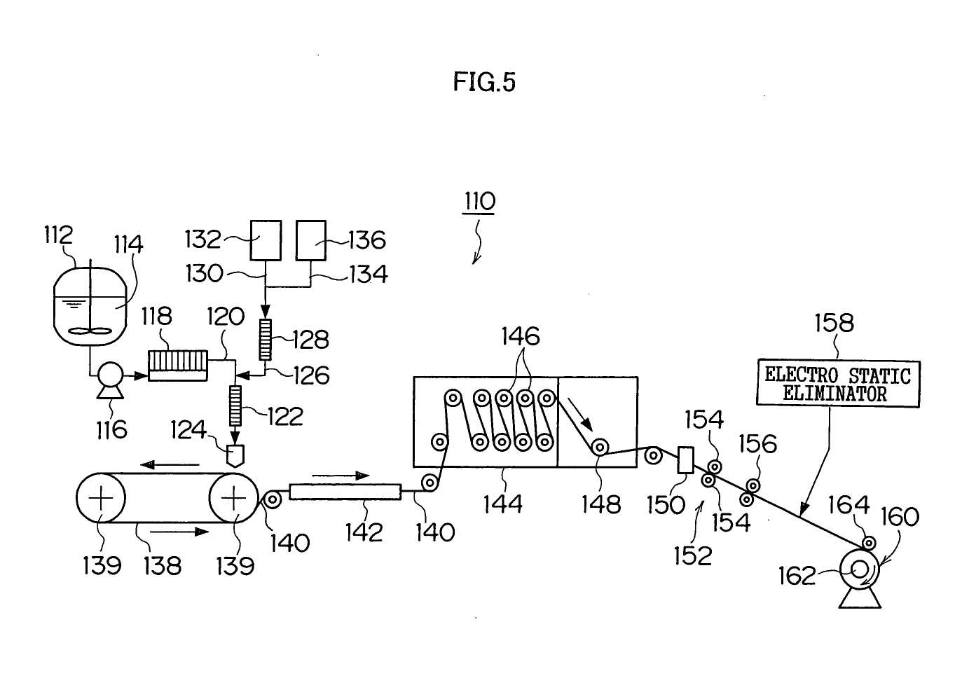

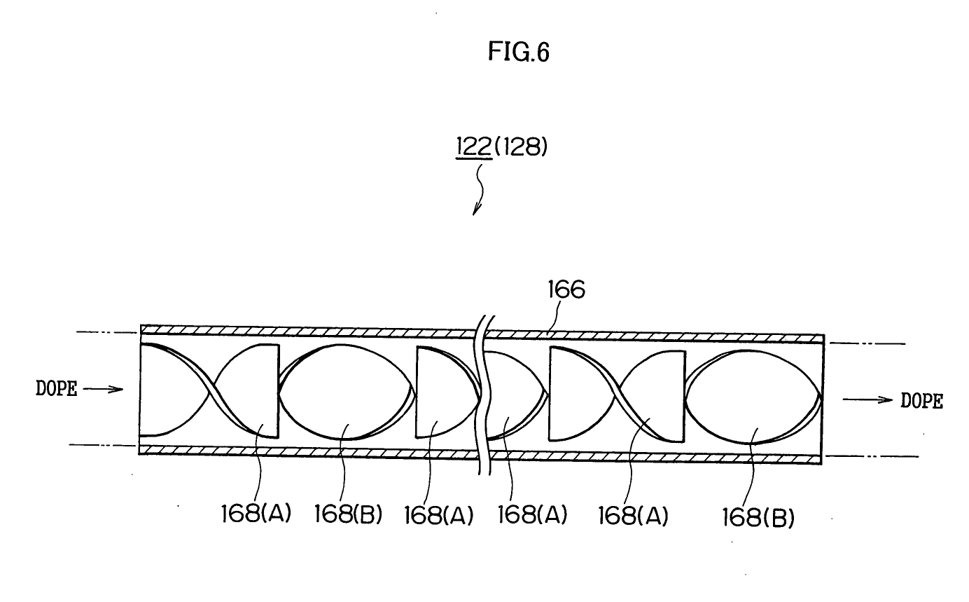

It may be appropriate that the first and second in-line mixers 122 and 128 are devices for continuously mixing materials, and for example, a static mixer is used. Static mixer is a static-type mixing machine having no drives, and as shown in FIG. 6, the static mixer comprises a plurality of elements 168 made up of a 180 degrees twist on a rectangular plate in a cylindrical casing 166. The elements 168 comprise right elements 168A and left elements 168B whose directions of applying a twist are opposite with each other. These right elements 168A and left elements 168B are located alternately in a state where both elements are shifted with one another by 90 degrees. When two types of liquids are supplied to the thus configured static mixer, the two types of liquids are fully mixed and become homogeneous by a division action of dividing the liquids into two portions by the elements 168, a conversion action of converting the liquids at the middle and peripheral sections of the casing 166 along the elements 168, and an inversion action of changing the rotation direction for each of the elements 168.

A cast band 138 is formed in a non-terminal state from a stainless plate or the like, and the surface is polished to a mirror-smooth state. In addition, the cast band 138 is wound up into a pair of drums 139, 139, and the cast band runs by rotation of at least one of the pair of drums 139, 139. The dope 114 is cast on the running cast band 138, and the dope is then stripped off after it obtains a self-supporting capacity. In this embodiment, a band casting is adopted, but a drum casting may also be carried out.

A film 140 stripped off from the cast band 138 is dried by passing through a draw drying unit 142 which performs drying by tentering and a roll drying unit 144. Particularly, the roll drying unit 144 fully dries the film 140 by carrying the film by means of rolls 146 while blowing dry air on the film 140. The thus dried film 140 is guided by a movable pass roll 148 at the last stage of the roll drying unit 144, and then the lateral position is controlled by an edge position control device 150.

After the lateral position is controlled, the film 140 is pressed by a pair of rollers 154, 154 of a knurling device 152, so that the film is knurled on the side end (knurling is a processing for providing fine projections and depressions and is also referred to as embossing or knurl processing). By this knurling, when the film 140 is wound up in a roll state, lateral displacement or the fault of black color can be suppressed by the knurling effect.

The knurled film 140 is trimmed by a trimming device 156, so that the width of the film is precisely determined. Static electricity charged in the trimmed film 140 is discharged by an electro static eliminator 158, and then the film 140 is wound up in a core 162 of a winding device 160 in a roll state, while being pressed by a contact roll 164.

Next, the action of the production system 110 with the above-described configuration will be explained.

The matting agent solution and the additive solution are separately prepared and filtrated, and each of both solutions is stored in the stock tanks 132 and 136. These solutions are mixed in the second in-line mixer 128, and then the obtained mixed solution is mixed with the dope 114 in the first in-line mixer 122. That is to say, the matting agent and the additive (ultraviolet absorber) are mixed twice, that is, in the first and second in-line mixers 122 and 128, so that the mixed solution becomes fully homogeneous and the matting agent is not aggregated, thereby preventing the generation of foreign materials caused by the matting agent.

Moreover, since the matting agent solution is mixed with the dope 114 at the latter stage of the filtration device 118 in the production system 110, the matting agent is not captured by the filtration device 118. Therefore, the generation of foreign materials caused by the effusion of the captured matting agent or the reduction of the amount of the matting agent can be prevented.

Thus, the production system 110 of the present embodiment enables to prevent the generation of foreign materials caused by the matting agent and to mix and disperse the matting agent uniformly, and further, enables to mix a stable amount of the matting agent in the dope. Accordingly, the produced film 140 contains an appropriate amount of the matting agent uniformly, and therefore fine projections and depressions are uniformly formed on the surface of the film 140. These fine projections and depressions enable to prevent reliably squeaks generated during transportation, or abrasion marks or adhesion generated during handling. Moreover, since the produced film 140 has few foreign materials mixed, the film has excellent optical properties such as high transparency, and so the film is suitable as an optical-purpose film such as a film for protecting a polarizing plate. Therefore, using the film 140, a polarizing plate with a high quality can be produced.

Moreover, since the matting agent solution and the additive solution are prepared separately and mixed in the production system 110 of the present embodiment, the amount of the matting agent and that of the additive can be controlled independently. Therefore, the production system 110 enables to produce easily the film 140 having different mixing ratios of the matting agents and the additives.

Furthermore, since the second in-line mixer 128 is used to mix the matting agent solution and the additive solution and then the first in-line mixer 122 is used to mix the mixed solution and the dope 114 in the production system 110, the processing can be carried out continuously, thereby providing good production efficiency.

Polymer, solvent, additive, matting agent and in-line mixer used in the present invention will be explained below.

(Polymer)

A polymer used in the present invention is not particularly limited, but cellulose ester is preferably used. Of cellulose esters, cellulose acylate is preferably used, and cellulose acetate is particularly preferably used. Further, of the cellulose acetates, cellulose triacetate having an average acetification degree of 57.5 to 62.5% is most preferably used. The term acetification degree is herein used to mean the amount of acetic acid bound to the compound per unit weight of cellulose. The acetification degree is determined according to the measurement and calculation of acetylation by ASTM: D-817-91 (a testing method of cellulose acetate and the like). In the present invention, cellulose acylate particles are used, in which 90% or more by weight of the used particles have a particle size of 0.1 to 4 mm, preferably 1 to 4 mm. Moreover, preferably 95% or more by weight of, more preferably 97% or more by weight of, further more preferably 98% or more by weight of, and most preferably 99% or more by weight of the particles have a particle size of 0.1 to 4 mm. Furthermore, 50% or more by weight of the used particles preferably have a particle size of 2 to 3 mm. More preferably 70% or more by weight of, further more preferably 80% or more by weight of, and most preferably 90% or more by weight of the particles have a particle size of 2 to 3 mm. The cellulose acylate particle preferably has an almost spherical form.

(Solvent)

Examples of a solvent used in the present invention include halogenated hydrocarbon, esters, ketones, ethers and others, but are not particularly limited. The solvent is not particularly limited as long as it has the purity of a commercially available product. The solvent may be used singly (100% by weight), or alcohol containing 1 to 6 carbon atoms, ketone, ester and ether may be mixed for use as a solvent. Examples of the solvent used include halogenated hydrocarbon (e.g. methylene chloride, etc.), esters (e.g. methyl acetate, methyl formate, ethyl acetate, amyl acetate, butyl acetate, etc.), ketones (e.g. acetone, methyl ethyl ketone, cyclohexanone, etc.), ethers (e.g. dioxane, dioxolane, tetrahydrofuran, diethyl ether, methyl-t-butyl ether, etc.) and others. Especially, halogenated hydrocarbon is preferably used as a main ingredient of a solvent used in the present invention because the polymer is easily dissolved therein when halogenated hydrocarbon exists. Specifically, 70 to 95% by weight of the solvent used to prepare a dope is preferably halogenated hydrocarbon.

(Additive)

Examples of an additive used in the present invention include a plasticizer, an ultraviolet absorber and others. When a cellulose triacetate film is used as a polarizing plate or a member for a liquid crystal display, an ultraviolet absorber is preferably used because it prevents the polarizing plate or the liquid crystal from deterioration. As such an ultraviolet absorber, preferably used is an ultraviolet absorber having an ability to absorb ultraviolet rays of a wave length of 370 nm or shorter and absorbing little visible radiation of a wave length of 400 nm or longer from the viewpoint of good liquid crystal display properties. Specific examples of an ultraviolet absorber preferably used by the present technique include an oxybenzophenone compound, a benzotriazole compound, a salicylate ester compound, a benzophenone compound, a cyanoacrylate compound, a nickel complex salt compound and other ultraviolet absorbers. The particularly preferred ultraviolet absorber is a benzotriazole compound or benzophenone compound. Specific examples of a benzotriazole ultraviolet absorber are shown below, but the present technique is not limited to the following compounds.

Included are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis-(n-octylthio)-6-(4-hydroxy-3,5-di-tert-butylanilino)-1,3,5-triazine, 2-(2′-hydroxy-3′,5′-di-tert-butylphenyl)-5-chlorobenzotriazole, (2-(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocyanurate or the like. Particularly preferred are (2,4-bis-(n-octylthio)-6-(4-hydroxy-3,5-di-tert-butylanilino)-1,3,5-triazine, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate]. Moreover, a hydrazine metal deactivator such as N,N′-bis[3-(3,5-di-tert-butyl-4-hydroxyphenyl)propionyl]hydrazine or a phosphorus processing stabilizer such as tris(2,4-di-tert-butylphenyl)phosphate may also be used in combination.

When an ultraviolet absorber is used as an additive solution, a mixed solution obtained by mixing a solvent and the ultraviolet absorber, or a solvent, a binder (preferably cellulose acetate) and the ultraviolet absorber is preferable. Examples of a solvent used include dichloromethane, a mixture of dichloromethane and lower alcohol, and preferably a mixture of methyl alcohol, ethyl alcohol, propyl alcohol, isopropyl alcohol, butyl alcohol and others. The solvent used in the production of a cellulose triacetate film is preferable as a solvent. The concentration of the ultraviolet absorber contained in the additive solution is preferably 5 to 30%, and more preferably 10 to 20% at a mass ratio. The concentration of the binder is preferably 0 to 10%, and more preferably 0 to 6%.

The amount of an ultraviolet absorber added is, at a mass ratio, preferably 1 to 10%, and more preferably 0.5 to 6.0% with respect to cellulose triacetate.

Moreover, the ultraviolet absorber described in Japanese Patent Application Publication No. 6-148430 is also preferably used. The ultraviolet absorber which is preferably used by the present technique, is preferably a benzotriazole ultraviolet absorber having high transparency, being excellent in an effect of preventing a polarizing plate or liquid crystal elements from deterioration, and in particular, providing less unnecessary coloration. The amount of an ultraviolet absorber used is different depending on the type of compounds or use conditions, but in general, the amount is preferably 0.2 to 5.0 g, more preferably 0.4 to 3.0 g, and particularly preferably 0.6 to 2.0 g per 1 m² of a cellulose triacetate film.

An ultraviolet absorber having a melting point of 30° C. or higher is preferable for the cellulose triacetate film obtained by the present technique, and further, an ultraviolet absorber having a melting point of 50° C. to 200° C. is used. The cellulose triacetate film obtained by the present technique is preferably used as a liquid crystal display member because of its high dimensional stability and good ultraviolet ray cutting performance. Liquid crystal display member means a member used for a liquid crystal display device, and examples of such a member include a polarizing plate, a polarizing plate protecting film, a phase-contrast plate, a view angle improving film, an antiglare film, a non-reflective film, an antistatic film and others. Of these, the cellulose triacetate film obtained by the present technique is preferably used as a polarizing plate or polarizing plate protecting film, which strictly requires dimensional stability. Particularly, a cellulose triacetate film, which is thinner than the conventional films, is required as a polarizing plate protecting film for recently developed notebook computers. Although producing a thinner film, in order to fully protect against ultraviolet rays, it is necessary to increase the amount of the ultraviolet absorber used per unit weight. Elution and precipitation of ultraviolet rays are likely to occur to a thinner polarizing plate protecting film. However, the cellulose triacetate film by the present technique containing an ultraviolet absorber having a melting point of 100° C. or higher comprises an increased amount of the ultraviolet absorber, and though the film is made thinner, few ultraviolet rays are eluted and precipitated. Therefore, the present film has an extremely high merit in the production process.

A plasticizer is included in the cellulose triacetate film. As a plasticizer, known plasticizers used for cellulose triacetate can be used. Examples are: phosphate esters such as triphenyl phosphate (hereinafter referred to as TPP), biphenyl diphenyl phosphate (hereinafter referred to as BDP), tricresyl phosphate, cresyl diphenyl phosphate, octyl diphenyl phosphate, trioctyl phosphate, tributyl phosphate; phthalic esters such as diethyl phthalate, dimethoxyethyl phthalate, dimethyl phthalate, dioctyl phthalate, dibutyl phthalate, di-2-ethylhexyl phthalate; and glycolic esters such as triacetin, tributyrin, butyl phthalyl butyl glycolate, ethyl phthalyl glycolate, methyl phthalyl ethyl glycolate. Each of these plasticizers may be used singly, or a plurality of these plasticizers may be mixed and used as necessary. Moreover, the total amount of the plasticizer may be mixed into the additive solution, or it is also possible that a portion of the plasticizer is mixed when the original dope is processed and then the remaining portion is mixed into the additive solution. When a portion is mixed into the original dope, the type and composition of plasticizers mixed into each of the original dope and the additive solution may be identical or different.

When a plasticizer is used as an additive solution, a solution of the solvent and the plasticizer, or a mixed solution of the solvent, the binder (preferably cellulose acetate) and the plasticizer is preferable. Examples of a solvent used include dichloromethane, a mixture of dichloromethane and lower alcohol, and preferably a mixture of methyl alcohol, ethyl alcohol, propyl alcohol, isopropyl alcohol, butyl alcohol and others. The solvent used in the production of a cellulose triacetate film is preferable as a solvent. The concentration of the plasticizer contained in the additive solution is preferably 5 to 40%, and more preferably 15 to 30% at a mass ratio. The concentration of the binder is preferably 0 to 10%, and more preferably 0 to 6%.

The ratio of the plasticizer contained in the obtained film is, at a mass ratio, preferably 1 to 20%, more preferably 5 to 15% when it is used as a liquid crystal member such as a polarizing plate, and most preferably 8 to 15%.

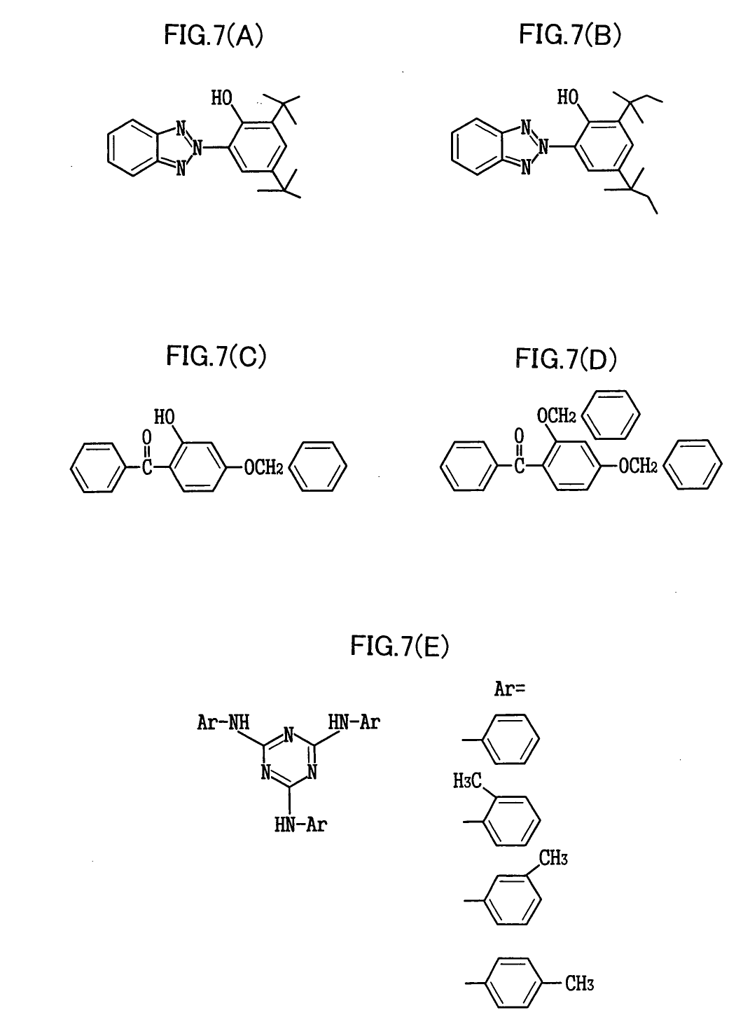

Triazine compounds used as materials for a biaxial film or view angle expanding film include compounds shown in FIGS. 7(A) to 7(E). When the triazine compound is used as an additive solution, a solution of the solvent and the triazine compound, or a mixed solution of the solvent, the binder (preferably cellulose acetate) and the triazine compound is preferable. Examples of the solvent used include dichloromethane, a mixture of dichloromethane and lower alcohols, and preferably a mixture of methyl alcohol, ethyl alcohol, propyl alcohol, isopropyl alcohol, butyl alcohol and others. The solvent used in the production of a cellulose triacetate film is preferable as a solvent. The concentration of the triazine compound contained in the additive solution is preferably 5 to 30%, and more preferably 10 to 20% at a mass ratio. The concentration of the binder is preferably 0 to 10%, and more preferably 0 to 6%. The ratio of the triazine compound contained in the obtained film is, at a mass ratio, preferably 0.5 to 10%, and more preferably 1 to 8% when it is used as a liquid crystal member such as a polarizing plate.

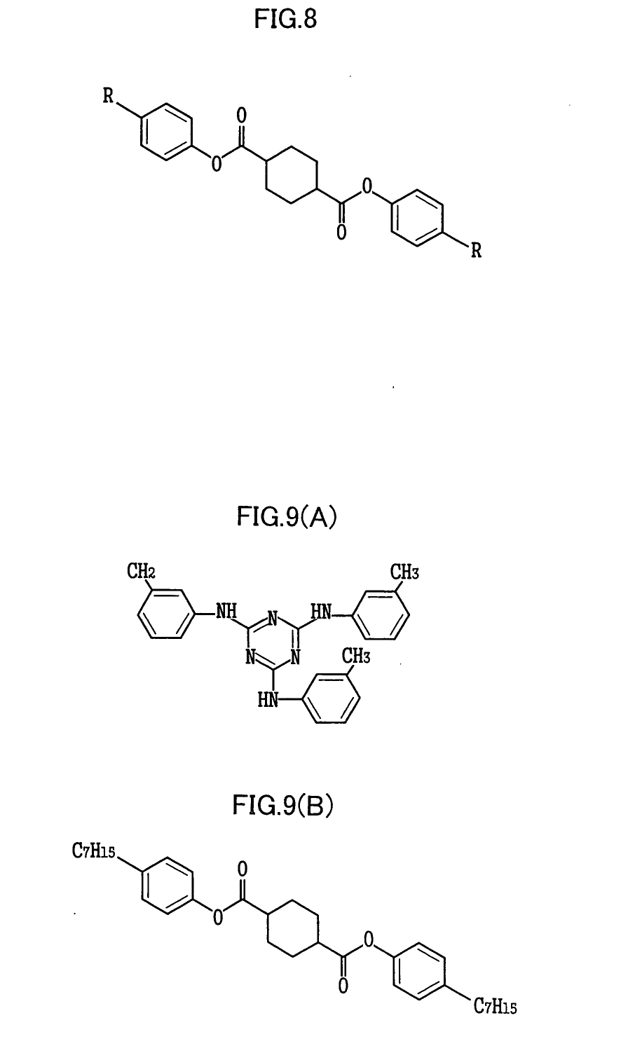

As shown in FIG. 8, a cyclohexane trans-dicarboxylic-ester compound is used as a material for a λ/4 film. In FIG. 8, examples of the structural formula of end R-chain include not only —C₇H₁₅ but also substituents such as —COO—C₈H₁₇, —COO—C₉H₁₉, —COO—C₁₀H₂₁, —(CH₂)—COO—C₇H₁₅, —(CH₂)₂—COO—C₇H₁₅, —(CH₂)₂—OCO—C₉H₁₉, —OCO—C₅H₁₁, —OCO—C₇H₁₅, —OCO—C₈H₁₇, —OCO—C₉H₁₉, —OCO—C₁₁H₂₃, C₈H₁₇O—C₆H₄—(CH₂)O—C₆H₄—O(CH₂)—C₆H₄—OC₈H₁₇, C₈H₁₇—C₆H₄—C₄H₈N₂—C₆H₄—C₈H₁₇, C₂H₅—C₆H₄—C₃H₅O₂B—C₆H₅ and others. When a cyclohexane trans-dicarboxylic-ester compound is used as an additive solution, a solution of the solvent and the trans-dicarboxylic-ester compound, or a mixed solution of the solvent, the binder (preferably cellulose acetate) and the cyclohexane trans-dicarboxylic-ester compound is preferable. Examples of the solvent used include dichloromethane, a mixture of dichloromethane and lower alcohols, and preferably a mixture of methyl alcohol, ethyl alcohol, propyl alcohol, isopropyl alcohol, butyl alcohol and others. The solvent used in the production of a cellulose triacetate film is preferable as a solvent. The concentration of the cyclohexane trans-dicarboxylic-ester compound contained in the additive solution is preferably 5 to 30%, and more preferably 10 to 20% at a mass ratio. The concentration of the binder is preferably 0 to 10%, and more preferably 0 to 6%. The ratio of the cyclohexane trans-dicarboxylic-ester compound contained in the obtained film is, at a mass ratio, preferably 0.5 to 10%, and more preferably 1 to 5% when it is used as a liquid crystal member such as a polarizing plate.

To the dope, various additives such as a releasing agent, a release promoting agent and a fluorine surfactant may be added as necessary at any stage between before and after the preparation of the dope.

(Matting Agent)

Matting agent is fine particles dispersed in the dope to prevent the produced film from abrasion marks generated when handling it or deterioration by transportation, and it is also called antiblocking agent or antisqueak agent. The average height of a projection on the surface of the matting agent is preferably 0.005 to 10 μm, and more preferably 0.01 to 5 μm. It is better that a large number of projections are on the surface of the matting agent. However, when the number of projections is over what is needed, it becomes a problem of causing a haze. A preferred projection could be a sphere, as long as it has the above average projection height. When an undetermined form of matting agent having projections is used, the amount of projections contained is 0.5 to 600 mg/m², and more preferably 1 to 400 mg/m².

The matting agent is not particularly limited as long as it is a material having the above-described functions. Specific examples of a preferred matting agent include, as an inorganic compound, a compound comprising silicon such as silicon dioxide, titanium dioxide, zinc oxide, aluminum oxide, barium oxide, zirconium oxide, strongtium oxide, antimony oxide, tin oxide, tin oxide-antimony, calcium carbonate, talc, clay, calcined kaoline, calcined calcium silicate, calcium silicate hydrate, aluminum silicate, magnesium silicate, calcium phosphate and others, and more preferably an inorganic compound comprising silicon and zirconium oxide. Of these, silicon dioxide is particularly preferably used because it can reduce the turbidity of a cellulose triacetate film. As particles of silicon dioxide, for example, commercially available products having trade names such as Aerogil R972, R974, R812, 130, 200, 300, R202, OX50 and TT600 (all manufactured by Nihon Aerogil Co., Ltd.) can be used. As particles of zirconium oxide, for example, commercially available products having trade names such as Aerogil R976 and R811 (manufactured by Nihon Aerogil Co., Ltd.) can be used.

Examples of a matting agent from an organic compound include the disintegrated classification products of organic polymeric compounds such as polytetrafluoroethylene, cellulose acetate, polystyrene, polymethyl methacrylate, polypropyl methacrylate, polyethylene carbonate, acryl styrene resin, silicon resin, polycarbonate resin, benzoguanamine resin, melamine resin, polyolefin powders, polyester resin, polyamide resin, polyimide resin, polyfluoroethylene resin and starch. Of these, silicon resin is preferably used. Of silicon resins, silicon resin having a three-dimensional reticular structure is particularly preferable, and for example, commercially available products having trade names such as Tospearl 103, Tospearl 105, Tospearl 108, Tospearl 120, Tospearl 145, Tospearl 3120 and Tospearl 240 (all manufactured by Toshiba Silicones Co., Ltd.) can be used.

Moreover, a polymeric compound synthesized by suspension polymerization, a polymeric compound made in a spherical form by spray-dry method or dispersion method, or an inorganic compound can be used. Furthermore, a similar material having a greater particle size of 0.1 to 10 μm and/or the fine particles can be added so as to use them as antiglare layers. In this case, 0.5 to 20% by mass of fine particles are preferably added. Preferred examples of these fine particles include silicon dioxide such as silica, and specific examples of such silicon dioxide include Sylysia manufactured by Fuji Silysia Chemical Co., Ltd., Nipsil E manufactured by Nippon Silica Industrial Co., Ltd., and others.

For the fine particles by the present technique, fine particles having an alkyl or aryl group containing 2 to 20 carbon atoms on the surface are preferably used. An alkyl group containing 4 to 12 carbon atoms is more preferable, and that containing 6 to 10 carbon atoms is further preferable. The smaller the number of carbon atoms is, the more excellent dispersibility the fine particle has, and the larger the number is, the less reaggregation occurs when the fine particles are mixed with a dope.

Among materials such as fine particles having an alkyl group containing 2 to 20 carbon atoms on the surface and fine particles having an aryl group on the surface, which are used by the present technique, examples of an inorganic compound include silicon dioxide, titanium dioxide, aluminum oxide, zirconium oxide, calcium carbonate, talc, clay, calcined kaoline, calcined calcium silicate, calcium silicate hydrate, aluminum silicate, magnesium silicate and calcium phosphate. Silicon dioxide, titanium dioxide and zirconium oxide are preferable, and of these, a compound containing silicon, particularly silicon dioxide is preferable. In addition, a silica fine particle having modification with silicon oil on the surface and a fine particle of spherical monodisperse silica are also preferably used.

The fine particle of an inorganic compound having an alkyl group containing 2 to 20 carbon atoms on the surface can be obtained, for example, by treating the fine particle of silicon dioxide with octylsilane. Moreover, the fine particle of an inorganic compound having a phenyl group on the surface can be obtained, for example, by treating the fine particle of silicon dioxide with trichlorophenylsilane.

Among materials such as the fine particles having an alkyl group containing 2 to 20 carbon atoms on the surface and the fine particles having a phenyl group on the surface, examples of a polymer include silicon resin, fluorocarbon resin and acryl resin, and polymethacrylate is particularly preferable. As described above, a compound containing silicon is preferable, and the compound is particularly preferably silicon dioxide or silicon resin having a three-dimensional reticular structure, silicon dioxide being most preferable.

In a preferred embodiment, the matting agent is previously dissolved using a solvent or binder (preferably cellulose triacetate), or in some cases, the matting agent is dispersed so that it is used as a stable solution.

In terms of suppression of haze, the primary average particle size of the matting agent is preferably 0.001 to 20 μm, more preferably 0.001 to 10 μm, further more preferably 0.002 to 1 μm, and particularly preferably 0.005 to 0.5 μm. The primary average particle size of the fine particle is measured with a transmission electron microscope. The apparent specific gravity of the fine particle is preferably 70 or more g/l, more preferably 90 to 200 g/l, and particularly preferably 100 to 200 g/l. For example, commercially available products having trade names such as Aerogil 200 and Aerogil R972V (both manufactured by Nihon Aerogil Co., Ltd.) can be used as these particles.

Examples of a method for preparing the dispersion solution of the matting agent by the present technique include the following 4 types of methods: (1) after mixing and stirring a solvent and the matting agent, a matting agent dispersion solution is prepared with a dispersing device, (2) after mixing and stirring a solvent and the matting agent, a matting agent dispersion solution is prepared with a dispersing device, separately, a small amount of cellulose triacetate is added to a solvent followed by stirring and dissolution, and the matting agent dispersion solution is added to this and stirred, (3) a small amount of cellulose triacetate is added to a solvent followed by stirring and dissolution, and a matting agent is added to this and the obtained mixture is dispersed with a dispersing device so as to obtain a matting agent dispersion solution, and (4) after a dope of a solvent and cellulose triacetate and a matting agent are mixed while stirring, the mixture is dispersed with a dispersing device so as to obtain a matting agent dispersion solution.

The dispersion solution can also be used as a matting agent additive solution by diluting with a solvent or binder (preferably cellulose triacetate) solution. Moreover, it is preferable to filtrate the matting agent dispersion solution and the matting agent additive solution. Differing from the filtration after the preparation of a dope (that is, filtration by the filtration device 118), the viscosity of an additive is low in this filtration and thereby pressure is not increased. Therefore, the matting agent retained by a filter is not run off by pressure, and foreign materials caused by the matting agent are not generated. Moreover, this filtration has an advantage that the diameter of a filter can be selected depending on the type of the matting agent, being regardless of the dope.

When silicon dioxide fine particles are mixed and dispersed using a solvent or the like, the concentration of silicon dioxide is preferably 0.1 to 30% by mass, more preferably 0.2 to 20% by mass, and most preferably 0.3 to 10% by mass.

Examples of the solvent used include dichloromethane, a mixture of dichloromethane and lower alcohols, and preferably a mixture of methyl alcohol, ethyl alcohol, propyl alcohol, isopropyl alcohol, butyl alcohol and others. The solvent used in the production of a cellulose triacetate film is preferable as a solvent.

The amount of silicon dioxide fine particles added to cellulose triacetate is 0.01 to 0.3 parts by mass, and more preferably 0.02 to 0.2 parts by mass with respect to 100 parts by mass of cellulose triacetate.

For dispersion, examples of a media dispersing device include Attritor, ball mill, sand mill, Dino mill and others. Examples of a medialess dispersing device include an ultrasonic type, a centrifugal type, a high-pressure type and others.

(In-line Mixer)

In-line mixer is a device for performing in-line addition and mixing, and examples of an in-line mixer which is preferably used include a static mixer (manufactured by Noritake Co., Ltd., and Toray Engineering Co., Ltd.), SWJ (Toray static mixer, Hi-Mixer) and others.

### EXAMPLES

The present invention will be explained in detail in the following examples. However, the examples are not intended to limit the embodiments of the present invention.

### Example 1

The preparation of a dope was carried out using the dope preparation line shown in FIG. 1. As a solvent for the dope preparation, a mixed solvent obtained by mixing methylene chloride as halogenated hydrocarbon and a mixed solution of alcohols (mixing ratio; methanol:n-butanol=34:1) at a ratio of 83:17 was supplied to the solution tank 12. With respect to this mixed solvent, 20% by weight of cellulose triacetate (acetification degree: 60%) as a polymer was supplied to the solution tank 12 by the measuring apparatus 14. Moreover, with respect to cellulose triacetate, 11.0% by weight of a mixture of TPP and BDP as plasticizers (weight mixing ratio; TPP:BDP=2:1) was supplied to the solution tank 12. The obtained mixture was stirred by rotating the stirring blade 18 at 80 rpm for 30 minutes by the motor 17 with an output of 45 kW so as to produce the roughly dissolved solution 19. The solution was stored in the storage tank 20, and then supplied to the heater 26 so as to raise the temperature of the solution to 85° C. by in-line temperature raising followed by retaining it for 10 minutes. When the obtained solution was visually checked, no insoluble products of the polymer were not confirmed. The solution was passed through the filtration filter 28 to remove impurities contained in materials, so that the dope 38 was obtained.

Next, using the film production system 50 shown in FIG. 2, the film 62 was produced from the dope 38 obtained by the above-described method. The dope 38 used for film production was cast from the casting die 60 onto the cast band 59 at 50° C. Casting was carried out so that the thickness of the film 62 became 80 μm after drying. After the film 62 was dried on the cast band 59 until it had a self-supporting capacity, the film was stripped off by the stripping roller 61 and then dried by the tenter 63 for 10 minutes, while being carried. Thereafter, the film 62 was dried at 130° C. for 30 minutes in the dry zone 52 and then wound up by the winding up machine 65. When the retardation (Rth) of the obtained film 62 was measured with an ellipsometer, the value at a wave length of 632.8 nm was 40 nm, and so it was found that the obtained film had excellent optical isotropy.

### Comparative Example 1

A mixture having the same composition as in Example 1 was dissolved in the solution tank 12 shown in FIG. 1. The mixture was stirred by rotating the stirring blade 18 at 80 rpm by the motor 17 with an output of 45 kW. It took 5 hours to completely dissolve the polymer.

As described above, when a dope was prepared by the method for preparing a dope of the present invention, the preparation time was less than 1 hour. In contrast, when the dope was prepared by only the conventional stirring, it took 5 hours to prepare the dope.

### Examples 2 to 7 and Comparative Example 2

A dope A for production of a film, a matting agent B, an ultraviolet absorber C, a plasticizer D, a triazine compound E, a cyclohexane trans-dicarboxylic-ester compound F, and a mixture G of a plasticizer and a cyclohexane trans-dicarboxylic-ester compound were prepared separately, and these materials were mixed by the undermentioned method. Thereafter, a film was produced by a casting film production method and the number of foreign materials contained in the film was compared. Incidentally, the explanation about the dope A for film production, the matting agent B, the ultraviolet absorber C, the plasticizer D, the triazine compound E, the cyclohexane trans-dicarboxylic-ester compound F, and the mixture G of the plasticizer and the cyclohexane trans-dicarboxylic-ester compound will be made at the end of Examples.

In Example 2, first, the matting agent solution B was mixed into the ultraviolet absorber solution C by a static mixer (38 elements). Then, the mixed solution was added to the dope A and mixed by a static mixer (42 elements). Using this dope, a dried film having a thickness of 80 μm was obtained by a casting film production method. This time, the ultraviolet absorber was set at 1.04% by weight in the dried film, and the matting agent was set at 0.13% by weight therein.

In Example 3, the ultraviolet absorber was set at 2.08% by weight in the dried film, and a dried film having a thickness of 40 μm was obtained by the same method as in Example 2.

In Example 4, first, the matting agent B was mixed into the plasticizer D by a static mixer (38 elements). Then, this mixed solution was added to the dope A and mixed by a static mixer (42 elements), and after the dope was mixed, the ultraviolet absorber C was added thereto and mixed by a static mixer (36 elements). Thereafter, a dried film having a thickness of 80 μm was obtained by the same method as in Example 2. This time, the ultraviolet absorber was set at 1.04% by mass in the dried film. The matting agent was set at 0.13% by mass in the dried film, and the plasticizers including the original plasticizer was set at 13.0% by mass therein.

In Example 5, the solution of the matting agent B was mixed into the solution of the triazine compound E by a static mixer (38 elements). A dried film having a thickness of 80 μm was obtained from the mixed solution by the same method as in Example 2. This time, the triazine compound was set at 4.46% by mass in the dried film. The matting agent was set at 0.13% by mass therein.

In Example 6, the solution of the matting agent B was mixed into the solution of the cyclohexane trans-dicarboxylic-ester compound F by a static mixer (38 elements). A dried film having a thickness of 80 μm was obtained from the mixed solution by the same method as in Example 2. This time, the cyclohexane trans-dicarboxylic-ester compound was set at 1.76% by mass in the dried film. The matting agent was set at 0.13% by mass therein.

In Example 7, the solution of the matting agent B was mixed into the mixture G of a plasticizer and a cyclohexane trans-dicarboxylic-ester compound by a static mixer (38 elements). A dried film having a thickness of 80 μm was obtained from the mixed solution by the same method as in Example 2. This time, the cyclohexane trans-dicarboxylic-ester compound was set at 1.71% by mass in the dried film, and the plasticizers including the original plasticizer was set at 13.0% by mass therein. The matting agent was set at 0.13% by mass therein.

In Comparative example 2, the matting agent solution B was added to the dope A and mixed by a static mixer (42 elements). The ultraviolet absorber C was added to the mixed dope and then mixed by a static mixer (36 elements). Thereafter, the mixed dope was cast to produce a film, and the film was dried so as to obtain a dried film having a thickness of 80 μm. The ratio of the ultraviolet absorber and the matting agent in the dried film was set at the same as in Example 2.

The number of foreign materials contained in the film was counted and shown in Table 1. The measurement of foreign materials was carried out by visually checking an area of 720 cm², and also by counting over 10 μm with an optical microscope of a magnification of 200 times. With regard to the comparative example, the value was provided while 7.2 cm² was converted to 720 cm².

TABLE 1

| | Number of foreign materials in film/720 cm² |
|---|---|
| Example 2 | 1 |
| Example 3 | 1 |
| Example 4 | 1 |
| Example 5 | 1 |
| Example 6 | 1 |
| Example 7 | 1 |
| Comparative example 2 | 36,000 |

It is considered that, in Comparative example 2, the matting agent was not fully dispersed but aggregated because the matting agent solution B was directly mixed into the dope A, and that the film contained a large number of foreign materials.

In contrast, in Examples, since the matting agent B was first mixed and dispersed in the additive and then the obtained product was mixed into the dope A, the matting agent was fully dispersed and mixed, and thereby the number of foreign materials in the film could significantly be reduced.

The method for preparing the dope A for production of a film, the matting agent solution B, the ultraviolet absorber solution C, the plasticizer D, the triazine compound E, the cyclohexane trans-dicarboxylic-ester compound F, and the mixture G of a plasticizer and a cyclohexane trans-dicarboxylic-ester compound will be explained below.

(Preparation of Dope A for Film Production)

A component consisting of 16.96% by weight of cellulose triacetate (acetification degree: 60.8%), 1.36% by weight of triphenyl phosphate, 0.68% by weight of biphenyl diphenyl phosphate, 70.47% by weight of dichloromethane and 10.53% by weight of methanol was stirred and dissolved. This dope was filtrated with a set of a flannel (Kataneru), a filter paper (#63, manufactured by Toyo Filter Paper Co., Ltd.) and a plain cotton fabric (Kanekin), then filtrated with a sintered metal filter (Nippon Seisen 06N, nominal pore size: 10 μm), and further filtrated with another sintered metal filter (Nippon Seisen 12N, nominal pore size: 40 μm).

(Preparation of Matting Agent Solution B)

A solution consisting of 2.00% by weight of silica (Aerogil R972 manufactured by Nihon Aerogil Co., Ltd.), 10.53% by weight of the filtrated dope A for film production, 76.10% by weight of dichloromethane and 11.37% by weight of methanol was dispersed by an Attritor so that a volume average particle size became 0.3 μm. Herein, the volume average particle size was measured by a particle size distribution measuring device LA920 manufacture by Horiba Ltd. The obtained solution was filtrated with 10 μm of Astropore (manufactured by Fuji Photo Film Co., Ltd.), and further filtrated with 10 μm of Astropore (manufactured by Fuji Photo Film Co., Ltd.) again.

(Preparation of Ultraviolet Absorber Solution C)

A solution consisting of 5.33% by weight of 2(2′-hydroxy-3′5′-di-tert-butylphenyl)-5-chlorobenzotriazole, 10.67% by weight of 2(2′-hydroxy-3′5′-di-tert-amylphenyl)benzotriazole, 21.05% by weight of the filtrated dope A for film production, 54.77% by weight of dichloromethane and 8.18% by weight of methanol was filtrated with 10 μm of Astropore (Fuji Photo Film Co., Ltd.)

(Preparation of Plasticizer Solution D)

A solution consisting of 16.67% by weight of triphenyl phosphate, 8.33% by weight of biphenyl diphenyl phosphate, 12.11% by weight of the filtrated dope A for film production, 54.71% by weight of dichloromethane and 8.18% by weight of methanol was filtrated with 10 μm of Astropore (Fuji Photo Film Co., Ltd.)

(Preparation of Triazine Compound Solution E)

A solution consisting of 15.38% by weight of a compound of the structural formula in FIG. 9(A), 13.89% by weight of the filtrated dope A for film production, 61.54% by weight of dichloromethane and 9.19% by weight of methanol was filtrated with 10 μm of Astropore (Fuji Photo Film Co., Ltd.)

(Preparation of cyclohexane trans-dicarboxylic-ester Compound Solution F)

A solution consisting of 15.00% by weight of a compound of the structural formula in FIG. 9(B), 12.11% by weight of the filtrated dope A for film production, 63.41% by weight of dichloromethane and 9.48% by weight of methanol was filtrated with 10 μm of Astropore (Fuji Photo Film Co., Ltd.)

(Preparation of Mixed Solution G of Plasticizer and cyclohexane trans-dicarboxylic-ester Compound)

A solution consisting of 10.00% by weight of the compound of the structural formula in FIG. 9(B), 8.87% by weight of triphenyl phosphate, 4.43% by weight of biphenyl diphenyl phosphate, 12.11% by weight of the filtrated dope A for film production, 56.39% by weight of dichloromethane and 8.43% by weight of methanol was filtrated with 10 μm of Astropore (Fuji Photo Film Co., Ltd.)

As described above, the inventive method for preparing a dope by dissolving a polymer in a solvent comprises a first step of roughly dissolving the polymer in the solvent, and a second step of promoting the dissolution by supplying the solution roughly dissolved in the first step so as to prepare the dope. The first step is completed at a time enough to prepare the roughly dissolved solution comprising the roughly dissolved polymer, and then the dissolution is promoted in the second step, so that the dope can be obtained. These steps enable to diminish the capacity of a solution tank, and with the reduction of the tank capacity, the power of a stirring blade or the like is also diminished. Using such a solution tank, gelatinous portions are completely dissolved until the solution passes through a filtration filter, and so the dope can be prepared.

According to the inventive solution film processing method for producing a film, when the dope obtained by the dope preparation method of the present invention is cast to produce a film, the obtained film has excellent optical isotropy.

Moreover, according to the inventive method for producing a cellulose triacetate film, a matting agent solution and an additive solution are prepared separately, both materials are then mixed, and further, the obtained mixed solution is mixed into a dope, so that the matting agent is fully mixed and dispersed, and thereby the generation of impurities caused by the matting agent can be prevented. Furthermore, since the matting agent and the additive are prepared separately, the amounts of both materials can arbitrarily be controlled.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method for producing a cellulose triacetate film comprising a matting agent and an additive, the method comprising:
a step of preparing a matting agent solution and an additive solution separately;
a step of mixing the matting agent solution and the additive solution into a mixed solution;
a step of continuously mixing the mixed solution with a dope of cellulose acetate; and
a step of casting the dope so as to produce the film.

2. The method according to claim 1, wherein the mixing steps are carried out using an in-line mixer.

3. The method according to claim 1, wherein the matting agent comprises at least one of silicon dioxide and a derivative of silicon dioxide.

4. The method according to claim 1, wherein the additive is an ultraviolet absorber comprising a benzotriazole compound.

5. The method according to claim 1, wherein the additive comprises a phosphoric ester plasticizer.

6. The method according to claim 1, wherein the additive comprises a triazine compound.

7. The method according to claim 1, wherein the additive comprises a cyclohexane trans-dicarboxylic-ester compound.

8. The method according to claim 1, wherein the additive comprises a mixture of at least two types selected from among an ultraviolet absorber comprising a benzotriazole compound, a phosphoric ester plasticizer, a triazine compound, and a cyclohexane trans-dicarboxylic-ester compound.

9. A cellulose triacetate film which is produced by the method according to claim 1.

10. A polarizing plate which is produced by using the cellulose triacetate film according to claim 9.
